(19) United States
(12) Patent Application Publication
(10) Pub. No.: US 2011/0121575 A1
(43) Pub. Date: May 26, 2011

(54) SYSTEMS, METHODS, AND KITS FOR POWER GENERATION

(76) Inventors: Gary Anetrini, Holly, MI (US); James Anetrini, Holly, MI (US)

(21) Appl. No.: 12/626,521

(22) Filed: Nov. 25, 2009

(51) Int. Cl. F03D 9/00; H02M 7/30

(52) U.S. Cl. 290/55; 363/102

(57) ABSTRACT

According to the invention, a system for generation of electrical power is provided. The system may include a wind driven element, a primary generator, a clutch, and an assist motor. The wind driven element may be configured to be rotated by wind thereby creating rotational motion, and further to provide the rotational motion. The primary generator may be configured to receive rotational motion, and further convert the rotational motion into electrical power. The clutch may be configured to selectively provide rotational motion from the wind driven element to the primary generator, and further to selectively not provide rotational motion from the wind driven element to the primary generator. The assist motor may be configured to create rotational motion, and further to selectively provide rotational motion to the primary generator independent of the wind driven element.

### BACKGROUND OF THE INVENTION

Wind generated electrical power has been commercially exploited in modern forms for at least the last twenty years. Because wind is a natural resource for which no supply costs exist, payback timelines for startup and maintenance costs can be accurately determined for a given geographical area with historical meteorological data. However, in some areas, the scarcity or unpredictability of wind conditions may make wind generated electrical power systems financially unfeasible, or at least financially unpredictable.

Solar or photovoltaic electrical power generation schemes have also been commercially viable for at least the last twenty years. Like wind generated electrical power, no supply costs exist for photovoltaic electrical power generation, only startup and maintenance costs. But again, like wind generated electrical power, in some areas, the scarcity or unpredictability of regular sunlight may make solar generated power systems financially unfeasible, or at least financially unpredictable.

However, when both sources, wind and solar, are combined, some of the unavailability and unpredictability of each source is buffered by the availability of the other. Unfortunately, existing schemes in the art for combining both power sources fail to take full advantage, and minimize the deficiencies, of each power source. Embodiments of the present invention provide solutions to these and other problems.

### BRIEF DESCRIPTION OF THE INVENTION

In one embodiment of the invention, a system for generation of electrical power is provided. The system may include a wind driven element, a primary generator, a clutch, and an assist motor. The wind driven element may be configured to be rotated by wind thereby creating rotational motion, and further to provide the rotational motion. The primary generator may be configured to receive rotational motion, and further convert the rotational motion into electrical power. The clutch may be configured to selectively provide at least a portion of the rotational motion from the wind driven element to the primary generator, and further to selectively not provide rotational motion from the wind driven element to the primary generator. The assist motor may be configured to create rotational motion, and further to selectively provide rotational motion to the primary generator independent of the wind driven element.

In another embodiment of the invention, a method for generating electrical power is provided. The method may include converting wind into first rotational motion with a wind driven element, where the first rotational motion is characterized by a speed. The method may also include providing the first rotational motion from the wind driven element to a primary generator. The method may further include converting, at the primary generator, the first rotational motion into electrical power. The method may additionally include generating a second rotational motion with a rotational motion source. The method may moreover include providing the second rotational motion from the rotational motion source to the generator, independent of the wind driven element, when the speed of the first rotational motion source drops below a minimum threshold.

In another embodiment of the invention, a kit for modifying a wind driven power generator is provided for wind driven power generators which include a wind driven element and a generator. The kit may include a clutch, a first rotational motion source, and a power source. The clutch may be coupled with a wind driven element and the generator. The first rotational motion source may be operably coupled with the generator, independent of the wind driven element. The power source may be configured to power the first rotational motion source.

### BRIEF DESCRIPTION OF THE DRAWINGS

The present invention is described in conjunction with the appended figures:

FIG. 1 is a block diagram of a system or kit of the invention for generating power with both solar and wind sources; and

FIG. 2 is a block diagram of a method of the invention for generating power with both solar and wind sources.

In the appended figures, similar components and/or features may have the same reference label. Where the reference label is used in the specification, the description is applicable to any one of the similar components having the same reference label.

### DETAILED DESCRIPTION OF THE INVENTION

The ensuing description provides preferred exemplary embodiments only, and is not intended to limit the scope, applicability or configuration of the disclosure. Rather, the ensuing description of the preferred exemplary embodiments will provide those skilled in the art with an enabling description for implementing a preferred exemplary embodiment. It being understood that various changes may be made in the function and arrangement of elements without departing from the spirit and scope of the invention as set forth in the appended claims. It will also be understood that any system, sub-system, component, or sub-component of any one embodiment discussed herein may be integrated or not integrated, added to or subtracted, with/to/from any system, sub-system, component, or sub-component of either the same or any other embodiment discussed herein.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. Some operations in a flowchart may not be performed in different embodiments of the invention. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination corresponds to a return of the function to the calling function or the main function.

In one embodiment of the invention, a system for generation of electrical power is provided. In some of these embodiments, the system may include a wind driven element, a primary generator, a clutch, and an assist motor.

In some embodiments, the wind driven element may be configured to be rotated by wind thereby creating rotational motion. In these or other embodiments, the wind driven element may be further configured to provide the rotational motion. In various embodiments, the wind driven elements may include, merely by way of example, a horizontal axis turbine, a vertical axis turbine, a Darrieus wind turbine, a Girmill wind turbine, and/or a Savonius wind turbine.

In some embodiments, the primary generator may be configured to receive rotational motion. In these or other embodiments, the primary generator may be further configured to convert the rotational motion into electrical power. In various embodiments, the primary generator may include an AC generator and/or a DC generator. In some embodiments, a mechanical transmission sub-system may couple the primary generator with other system components.

In some embodiments, the clutch may be configured to selectively provide at least a portion of the rotational motion from the wind driven element to the primary generator. In these or other embodiments, the clutch may be further configured to selectively not provide rotational motion from the wind driven element to the primary generator, and/or not provide rotational motion from the assist motor to the wind driven element. In various embodiments, the clutch may be self actuated, possible via whole or partial mechanical, electrical, and/or electro-mechanical operation, transferring all rotational motion from the wind driven element to the primary generator below a certain threshold rotational speed, and limiting the rotational speed to the threshold rotational speed when the wind driven element is exceeding that threshold speed. In other embodiments, the clutch may be controlled by a controller, possibly based on a measured wind speed or a rotational speed of a mechanical transmission element coupled with the wind driven element.

In some embodiments, the assist motor may be configured to create rotational motion. In these or other embodiments, the assist motor may be further configured to selectively provide rotational motion to the primary generator independent of the wind driven element. In various embodiments, the assist motor may include, merely by way of example, an AC and/or DC motor.

In some embodiments, systems, methods, and/or kits of the invention may also include a battery. In these or other embodiments, the battery may be configured to store electrical power. In some of these embodiments, the battery may be further configured to selectively provide electrical power to the assist motor.

In some embodiments, systems, methods, and/or kits of the invention may also include a photovoltaic cell. In these or other embodiments, the photovoltaic cell may be configured to convert light into electrical power. In some of these embodiments, the photovoltaic cell may be further configured to selectively provide electrical power to the assist motor.

In these or other embodiments, where a photovoltaic cell may be configured to selectively provide electrical power to the assist motor, such an embodiment may include the photovoltaic cell being configured to store electrical power in a battery, with the battery being configured to selectively provide electrical power to the assist motor.

In some embodiments, the wind driven elements of the invention may include an adjustable pitch wind driven blade. In some embodiments, the adjustable pitch wind driven blades may be self actuated, being perpendicular to oncoming wind at low wind speeds, and parallel to oncoming wind at high wind speeds, and at varying angles at varying speeds there-between. In other embodiments, the pitch of the adjustable pitch wind driven blades may be controlled by a controller, possibly based on a measured wind speed or a rotational speed of a mechanical transmission element coupled with the adjustable pitch wind driven blades.

In these or other embodiments, the system may also include a controller. In such embodiments, the controller may be configured to adjust a pitch of the adjustable pitch wind driven blades to maintain a particular rotational speed of the primary generator. In some of these embodiments, the controller may be further configured to selectively activate the clutch to maintain a minimum, maximum, optimal, and/or particular rotational speed of the primary generator. In various embodiments, the controller may be further configured to selectively activate the assist motor to maintain a minimum, maximum, optimal, and/or particular rotational speed of the primary generator, possibly when the wind speed or rotational speed from the wind driven element drops below a minimum threshold.

In some embodiments, the systems of the invention may also include a wind and/or one or more rotational speed sensor. In embodiments with rotational speed sensors, the rotational speed sensors may be configured to detect the rotational speed of the wind driven element and/or the primary generator. In embodiments where a controller of the invention is configured to activate the clutch to maintain a minimum, maximum, optimal, and/or particular rotational speed of the primary generator, the controller may be configured to engage the primary generator to the wind driven element when a wind speed, rotational speed of the wind driven element, and/or rotational speed of the primary generator drops below a certain threshold is detected by the wind sensor and/or rotational speed sensors.

In some embodiments, the systems of the invention may also include an assist generator. In these or other embodiments, the assist generator may be configured to receive rotational motion from the primary generator and convert the rotational motion into electrical power. This electrical power may be configured to power any sub-system of the invention, and/or be configured to provide power to external grids and/or external systems.

In some of these embodiments, the system may also include a battery configured to receive electrical power from the assist generator. In these or other embodiments, the battery may be configured to provide electrical power to a controller. Power from the battery may be configured to power any sub-system of the invention, and/or be configured to provide power to external grids and/or external systems.

In another embodiment of the invention, a method for generating electrical power is provided.

The method may include converting wind into a first rotational motion with a wind driven element, where the first rotational motion is characterized by a speed.

The method may also include providing the first rotational motion from the wind driven element to a primary generator.

The method may further include converting, at the primary generator, the first rotational motion into electrical power.

The method may additionally include generating a second rotational motion with a rotational motion source.

The method may moreover include providing the second rotational motion from the rotational motion source to the generator, independent of the wind driven element, when the speed of the first rotational speed drops below a minimum threshold.

In some embodiments, the method may also include converting light into electrical power with a photovoltaic cell, and providing electrical power from the photovoltaic cell to the second rotational motion source.

In some embodiments, the method may additionally include storing electrical power, and selectively providing such electrical power and/or other electrical power, to the assist motor.

In some embodiments, the wind driven element may include an adjustable pitch wind driven blade. In these or other embodiments, the method may furthermore include adjusting a pitch of the adjustable pitch wind driven blade to maintain a particular rotational speed of the primary generator.

In some embodiments, the method may moreover include ceasing provision of at least a portion of the first rotational motion from the wind driven element to the primary generator when the speed of the wind exceeds a maximum threshold.

In some embodiments, the method may also include providing a third rotational motion from the primary generator. In these embodiments the method may also include converting, at an assist generator, the third rotational motion into electrical power, and providing the electrical power from the assist generator to a controller.

In yet another embodiment of the invention, a kit for modifying a wind driven power generator is provided for wind driven power generators which include a wind driven element and a generator. In some embodiments, the kit may include a clutch, a first rotational motion source, and a power source.

In some embodiments, the clutch may be coupled with a wind driven element and the generator.

In some embodiments, the first rotational motion source may be operably coupled with the generator, independent of the wind driven element.

In some embodiments, the power source may be configured to power the first rotational motion source. In these or other embodiments, the power source may include a photovoltaic cell. In yet other embodiments, the power source may include a photovoltaic cell and a battery.

In some embodiments, the kit may also include a controller configured to control the first rotational motion source to maintain a minimum, maximum, optimal, and/or particular amount of power generation by the generator.

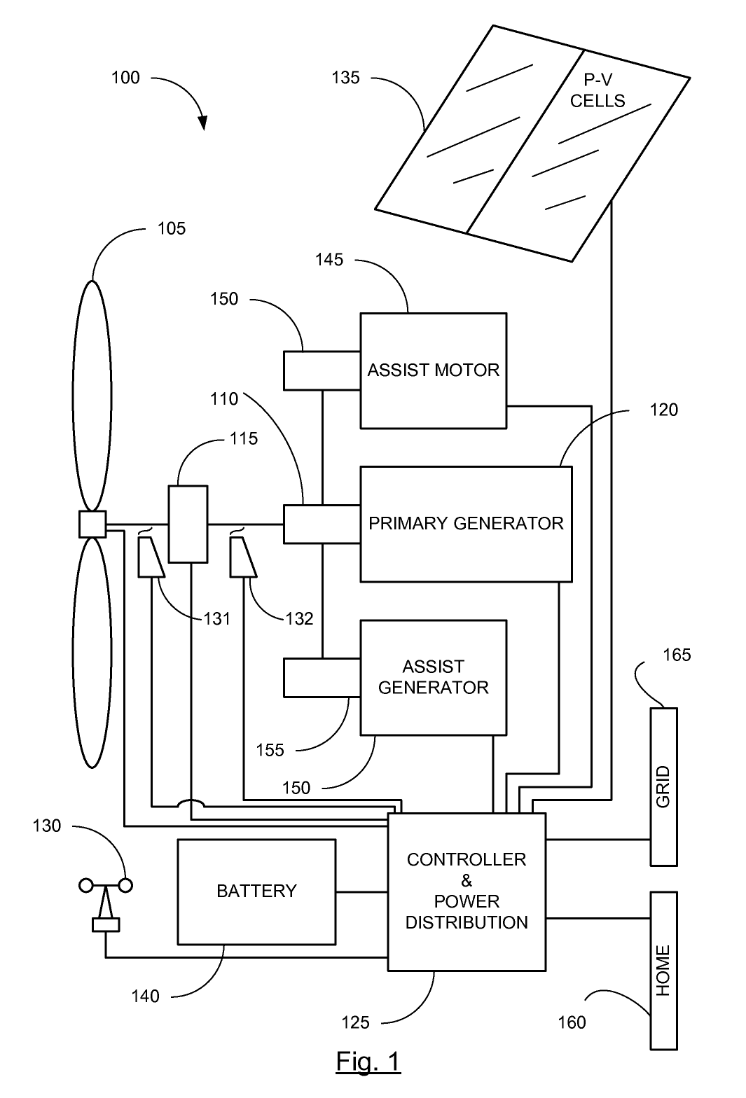

Turning now to FIG. 1, a block diagram of a system 100 or kit of the invention for generating power with both solar and wind sources is shown. In this exemplary embodiment, a wind driven element 105, shown here as a turbine with variable pitch blades, may be operable to receive wind and cause rotation. In some embodiments, wind driven element 105 may have a cage surrounding wind driven element 105 to protect wind driven element from damaging elements, for example, birds and/or airborne refuse. The rotation may be delivered to clutch 110, which is operable to disengage from shaft/transmission 115 of primary generator 120.

Clutch 110 may be either mechanical operated to engage/disengage at certain speeds, or controlled via controller 125 to accomplish the same operation. In some embodiments, the clutch may be configured to disengage at low wind speeds and/or at high wind speeds. Controller 125 may be in communication with wind speed detector 130 and/or one or both of rotational speed sensors 131, 132. Disengagement at low speeds may occur when wind/rotational speeds are not significant enough to turn primary generator 120 shaft/transmission 115 at a desired speed which may correspond to a certain minimum, maximum, optimal, and/or particular level of power generation.

System 100 may also include photovoltaic cells 135. Photovoltaic cells 135 may be configured to convert light into electrical power. Photovoltaic cells 135 may be located in any position, including, merely by way of example, the roof of a building, on a pole/support member to which at least a sub-portion of system 100 is coupled, and/or a curved or flat portion of the tail of a wind turbine within system 100. The electrical power generated by photovoltaic cells 135 may be used to power any sub-system of system 100, or such power may be stored in batteries 140. Alternatively, electrical power generated by photovoltaic cells 135 may be output by system 100 as will be further described below.

If wind/rotational speed drops below the threshold necessary to produce desired power generation from primary generator 120, then clutch 110 may be semi-disengaged, and assist motor 145 may be activated by controller 125. Semi-disengagement allows wind driven element 105 to continue transferring some or all of the rotational motion generated thereby to primary generator 120, without rotation generated from assist motor 145 causing additional rotation of wind driven element 105. Via assist motor 145 and shaft/transmission 150, primary generator 120 may generate power from the rotational motion received.

In the manner described above, primary generator 120 may continuously operate so long as power is available from wind from wind driven element 105 and/or assist motor 145 (which in turn may receive power from batteries 140, and/or more directly from photovoltaic cells 135). Furthermore, inertia of wind driven element 105 may be ignored in the system when assist motor 145 is powering primary generator 120, as clutch 110 can at least partially disengage wind driven element 105 from primary generator 120 and/or assist motor 145.

Batteries 140 may be recharged with power from primary generator 120, possibly when excess power is available. Additionally, assist generator 150 may, via shaft/transmission 155, generate power to recharge batteries 140 and/or operate controller 125.

At least some or all of the power generated by system 100 may be delivered directly to a user, in this embodiment shown as a home 160. Alternatively, at least some or all of the power generated by system 100 may be delivered to a power grid 165. Power grid 165 may also provide power back to any sub-system of system 100.

In some embodiments, controller 125 may also control the pitch of the variable pitch blades of wind driven element 105. In this manner, controller 125 can increase or decrease the speed of wind driven element 105 at different wind speeds, thereby adding another element of control to system 100.

Note that any portion, or all, of system 100 may be mounted on an end user structure. In some embodiments, for example, wind driven element 105 and/or photovoltaic cells 135 may be mounted on the roof of a residence or any other structure.

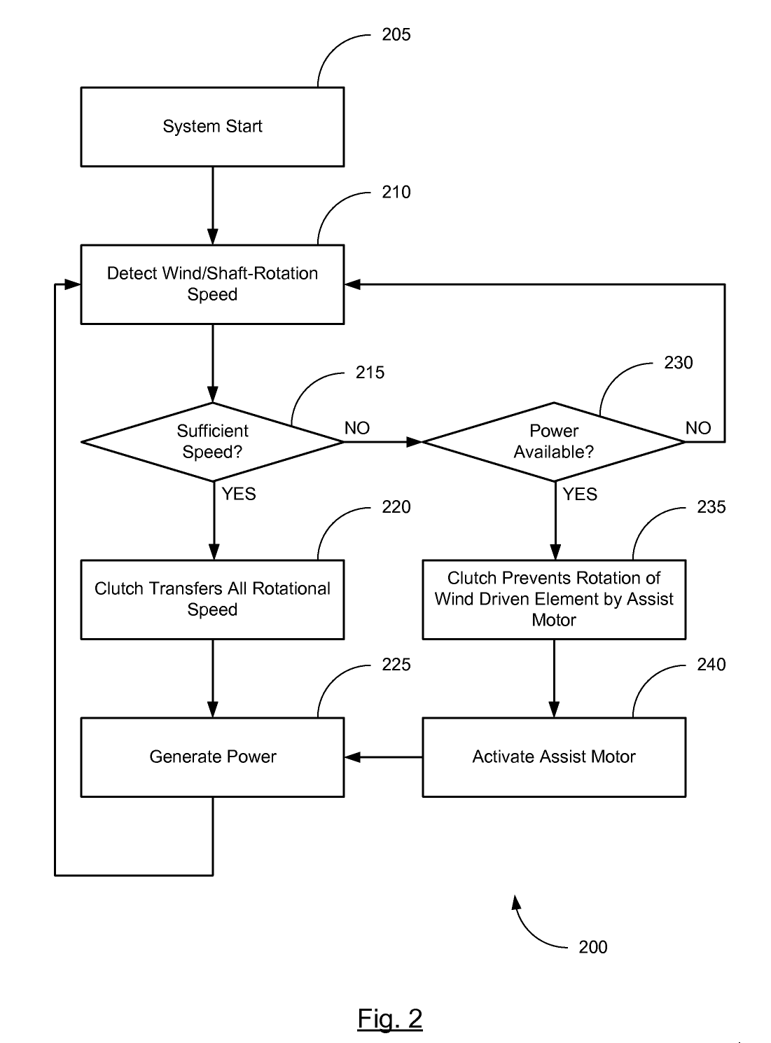

In FIG. 2, a block diagram of a method 200 of the invention for generating power with both solar and wind sources is shown.

At block 205, the system is started. At block 210, wind or rotational speed is detected. At block 215, it is determined if wind/rotational speed is sufficient to generate power via the wind driven element.

If wind/rotational speed is sufficient, then at block 220, the clutch is engaged such that all rotational speed is transferred to the generator. Power is then generated at block 225.

If wind/rotational speed is not sufficient, then at block 230, it is determined if there is sufficient stored or otherwise available power (possibly directly from photovoltaic cells) to power the assist motor. If there is not sufficient power to operate assist motor at a threshold level, and/or for a threshold time period, then the method returns to block 210.

If there is sufficient power to operate assist motor at a threshold level and/or for a threshold time period, then at block 235 the clutch disengages such that assist motor may power the generator without allowing the assist motor to cause additional rotation of the wind driven element. At block 240, assist motor 240 is activated, and power is generated at block 225. Wind speed may be checked again at block 210 to determine if wind and/or assist motor operation should be engaged, partially engaged, and/or disengaged.

A number of variations and modifications of the disclosed embodiments can also be used. For example, other power sources/systems may be used to power the assist motor. Merely by way of example, geothermal power sources, kinetic energy sources, tidal power sources, etc. may be used to power the assist motor. These or other exemplary sources not discussed more specifically herein may also be used to power other systems and sub-systems of the invention, including the controller.

The invention has now been described in detail for the purposes of clarity and understanding. However, it will be appreciated that certain changes and modifications may be practiced within the scope of the appended claims.

What is claimed is:

1. A system for generation of electrical power, the system comprising:
a wind driven element, wherein:
the wind driven element is configured to be rotated by wind, thereby creating rotational motion; and
the wind driven element is further configured to provide the rotational motion;
a primary generator, wherein:
the primary generator is configured to receive rotational motion; and
the primary generator is further configured to convert the rotational motion into electrical power;
a clutch, wherein:
the clutch is configured to selectively provide at least a portion of the rotational motion from the wind driven element to the primary generator; and
the clutch is further configured to selectively not provide rotational motion from the wind driven element to the primary generator; and
an assist motor, wherein:
the assist motor is configured to create rotational motion; and
the assist motor is further configured to selectively provide rotational motion to the primary generator independent of the wind driven element.

2. The system for generation of electrical power of claim 1, wherein the system further comprises:
a photovoltaic cell, wherein:
the photovoltaic cell is configured to convert light into electrical power; and
the photovoltaic cell is further configured to selectively provide electrical power to the assist motor.

3. The system for generation of electrical power of claim 2, wherein the system further comprises a battery, and wherein the photovoltaic cell being configured to selectively provide electrical power to the assist motor comprises the photovoltaic cell being configured to store electrical power in the battery and the battery being configured to selectively provide electrical power to the assist motor.

4. The system for generation of electrical power of claim 1, wherein the system further comprises a battery, and wherein:
the battery is configured to store electrical power; and
the battery is further configured to selectively provide electrical power to the assist motor.

5. The system for generation of electrical power of claim 1, wherein the wind driven element comprises an adjustable pitch wind driven blade.

6. The system for generation of electrical power of claim 5, wherein the system further comprises a controller, and wherein:
the controller is configured to adjust a pitch of the adjustable pitch wind driven blade to maintain a particular rotational speed of the primary generator; and
the controller is further configured to selectively activate the assist motor to maintain the particular rotational speed of the primary generator.

7. The system for generation of electrical power of claim 1, wherein the system further comprises a controller, and wherein:
the controller is further configured to selectively activate the assist motor to maintain a particular rotational speed of the primary generator.

8. The system for generation of electrical power of claim 7, wherein the system further comprises a rotational speed sensor, and wherein the controller being configured to selectively activate the assist motor to maintain a particular rotational speed of the primary generator comprises the controller being configured to activate the assist motor when a rotational speed below a minimum threshold is detected by the rotational speed sensor.

9. The system for generation of electrical power of claim 1, wherein the system further comprises an assist generator, and the assist generator is configured to receive rotational motion from the primary generator and convert the rotational motion into electrical power.

10. The system for generation of electrical power of claim 9, wherein the system further comprises a battery configured to receive electrical power from the assist generator, wherein the battery is configured to provide electrical power to a controller.

11. A method for generating electrical power, the method comprising:
converting wind into a first rotational motion with a wind driven element, wherein the first rotational motion is characterized by a speed;
providing the first rotational motion from the wind driven element to a primary generator;
converting, at the primary generator, the first rotational motion into electrical power;
generating a second rotational motion with a rotational motion source; and
providing the second rotational motion from the rotational motion source to the generator, independent of the wind driven element, when the speed of the first rotational motion drops below a minimum threshold.

12. The method for generating electrical power of claim 11, the method further comprising:
converting light into electrical power with a photovoltaic cell; and
providing electrical power from the photovoltaic cell to second rotational motion source.

13. The method for generating electrical power of claim 12, the method further comprising:
storing electrical power; and
selectively providing electrical power to the rotational motion source.

14. The method for generating electrical power, of claim 12 wherein the wind driven element comprises an adjustable pitch wind driven blade, the method further comprising:
adjusting a pitch of the adjustable pitch wind driven blade to maintain a particular rotational speed of the primary generator.

15. The method for generating electrical power of claim 12, the method further comprising:
ceasing provision of at least a portion of the first rotational motion from the wind driven element to the primary generator when the speed of the first rotational speed drops exceeds a maximum threshold.

16. The method for generating electrical power of claim 12, the method further comprising:
providing a third rotational motion from the primary generator;
converting, at an assist generator, the third rotational motion into electrical power; and
providing the electrical power from the assist generator to a controller.

17. A kit for modifying a wind driven power generator, wherein the wind drive power generator comprises a wind driven element and a generator, and wherein the kit comprises:
a clutch which may be coupled with a wind driven element and the generator;
a first rotational motion source which may be operably coupled with the generator, independent of the wind driven element; and
a power source configured to power the first rotational motion source.

18. The kit for modifying a wind driven power generator of claim 17, wherein the power source comprises a photovoltaic cell.

19. The kit for modifying a wind driven power generator of claim 17, wherein the power source comprises a photovoltaic cell and a battery.

20. The kit for modifying a wind driven power generator of claim 17, wherein the kit further comprises a controller configured to control the first rotational motion source to maintain a particular amount of power generation by the generator.
